(19) United States
(12) Patent Application Publication
(10) Pub. No.: US 2003/0048926 A1
(43) Pub. Date: Mar. 13, 2003

(54) Surveillance system, surveillance method and surveillance program

(76) Inventor: Takahiro Watanabe, Saitama (JP)

Correspondence Address: RABIN & CHAMPAGNE, PC, 1101 14TH STREET, NW, SUITE 500, WASHINGTON, DC, 20005, US

(21) Appl. No.: 10/167,446

(22) Filed: Jun. 13, 2002

(30) Foreign Application Priority Data
Sep. 7, 2001 (JP) 271162/2001

(51) Int. Cl. G06K 9/00

(52) U.S. Cl. 382/103

(57) ABSTRACT

The object of this invention is to provide a surveillance system whereby specific persons can be detected readily from visiting persons, without placing a large burden on the surveillance operator. The surveillance system detects a person depicted in a surveillance image, by means of a recording section 11, and creates an editable personal behavior table 15 for each person. The personal behavior table can be edited with regard to various items, depending on the objective, and a surveillance image depicting a person matching prescribed conditions can be identified. The identifying section 21 of the surveillance system uses a personal behavior table 15 of this kind to create a specific person table 24 depicting a person matching particular conditions, and then detects if a person compiled in the specific person table 24 is present amongst the visiting persons, by means of a detecting section 31.

### BACKGROUND OF THE INVENTION

1. Field of the Invention

The present invention relates to a surveillance system and surveillance method and surveillance program for automatically detecting a person matching prescribed conditions from surveillance images captured by means of a surveillance camera.

2. Description of Related Art

In the prior art, Japanese Patent Laid-open No. (Hei)10-66055 (hereinafter, called “reference”) discloses technology of this kind.

As described in the reference, conventionally, surveillance systems are provided wherein surveillance cameras are positioned in stores, such as convenience stores, supermarkets, and department stores, financial establishments, such as banks and savings banks, accommodation facilities, such as hotels and guesthouses, and other indoor facilities, such as entrance halls, elevators, and the like, images captured by the cameras being monitored and recorded in real time, whereby the situation in the facilities can be supervised.

Here, if the facility is a retail store, for example, then it is important to monitor the aspect of the persons inside the store (hereinafter, called the “customers”). However, surveillance images taken by surveillance cameras often do not show a customer. Therefore, in order to detect a person who may possibly have committed a theft (hereinafter, called a “suspect”), from a surveillance image, the surveillance images captured by surveillance cameras are temporarily recorded on a VTR, and then persons who give cause for suspicion are detected as candidate suspects from the surveillance images recorded on the VTR, by suspect detecting means. Such detection is performed by defining an object which enters the store and subsequently leaves the store without passing by the cash register as a candidate suspect, and then regarding people to whom this definition applies as candidate suspects (see the reference).

Thereupon, a person monitoring the store indicates a suspect region where a suspect is displayed on the surveillance image, by region indicating means. Accordingly, the surveillance system extracts the characteristic features of the suspect region thus indicated, and records these characteristic features in a recording section. The monitoring system then checks the surveillance image of the customer captured by the surveillance camera, using the characteristic features of the suspect region recorded in the recorded section. Thereby, the surveillance system is able to detect if that suspect visits the store again.

The surveillance system of the prior art defines a moving person who enters the store and then leaves the store without passing by the cash register as a candidate suspect. However, in this definition, it is not possible to detect all candidate theft suspects. For example, in the case of a person carrying a product A and a product B, who only settles payment of product B and then leaves, and consequently steals product A, the person is not detected as a candidate suspect.

Moreover, if a candidate suspect matching the definition described above is depicted on a surveillance image, then the surveillance operator must recognise the suspect by sight. However, since the number of candidate suspects is extremely high, this kind of confirmation places a very large burden on the surveillance operator.

Moreover, if there is a blind area in the surveillance image, then the candidate suspect may not be depicted in the surveillance image. In cases of this kind, even if the surveillance operator observes the image, he or she cannot confirm whether or not the candidate suspect is holding a product is his or her hand. Moreover, the suspect detecting means is not able to detect a suspect accurately.

In addition, the region indicating means increases the work of the surveillance operator in indicating the suspect region from the surveillance image. Accordingly, a conventional surveillance system places a burden on the surveillance operator.

### SUMMARY OF THE INVENTION

The present invention was devised in view of the problems of conventional surveillance systems, an object thereof being to provide a surveillance system and surveillance method whereby detection of various specific persons can be performed in a variety of fields, by detecting a person from a surveillance image, performing tracking and behavior recognition, creating personal behavior tables for respective persons, searching for a person having committed particular behavior from the behavior tables, and detecting the next occasion on which the person thus found visits the premises.

Therefore, the surveillance system according to the present invention comprises: a recording section for recognizing the behavior of a person depicted in a surveillance image, creating record items on the basis of the behavior, in an editable and processable format, and recording the record items in a personal behavior table; an identifying section for searching for a specific person on the basis of the record items recorded in the personal behavior table, and creating information for a specific person, and a specific person table wherein items for identifying a specific person are recorded; and a detecting section for detecting a person for whom information is recorded in the specific person table, from a surveillance image.

In a further surveillance system according to the present invention, the recording section comprises: a detecting and tracking section for detecting and tracking a person from the surveillance image; an attitude and behavior recognizing section for recognizing the attitude and behavior of the person; and a behavior record creating section for processing the recognition results of the attitude and behavior recognizing section into an editable and processable format.

In yet a further surveillance system according to the present invention, the identifying section comprises a specific person searching section for searching for a specific person on the basis of the record items recorded in the personal behavior table, and an input/output section for performing input/output of personal information in order to perform a search.

In yet a further surveillance system according to the present invention, the detecting section comprises a specific person detecting section for detecting a specific person for whom information is recorded in the specific person table, from the surveillance image, and a detection result outputting section for displaying the detected result.

In yet a further surveillance system according to the present invention, the detecting section and the recording section are able to input surveillance images of different angles, captured by a plurality of surveillance cameras.

In yet a further surveillance system according to the present invention, the detecting section, recording section and identifying section are located in either a client section or a server section.

A surveillance method according to the present invention, comprises the steps of: recognizing the behavior of a person depicted on a surveillance image, creating record items in an editable and processable format, on the basis of the behavior, and recording the record items, as well as transmitting same to a server section, to be performed in a client section; recording the record items, searching for a specific person on the basis of the record items, and sending information for the specific person thus found, to the client section, to be performed in the server section; and detecting the specific person from the surveillance image on the basis of the information for the specific person, to be performed in the client section.

A surveillance program according to the present invention performs detection of specific persons by causing a computer to function as: a recording section for recognizing the behavior of a person depicted in a surveillance image, creating record items on the basis of the behavior, in an editable and processable format, and recording the record items in a personal behavior table; an identifying section for searching for a specific person on the basis of the record items recorded in the personal behavior table, and creating information for a specific person, and a specific person table wherein items for identifying a specific person are recorded; and a detecting section for detecting a person for whom information is recorded in the specific person table, from a surveillance image.

### BRIEF DESCRIPTION OF THE DRAWINGS

FIG. 1 is a block diagram showing the composition of a surveillance system according to a first embodiment of the present invention;

FIG. 2 is a block diagram showing the composition of a recording section according to a first embodiment of the present invention;

FIG. 3 is a block diagram showing the composition of an identifying section according to a first embodiment of the present invention;

FIG. 4 is a block diagram showing the composition of a detecting section according to a first embodiment of the present invention;

FIG. 5 is a block diagram showing an example of a human region moving image according to a first embodiment of the present invention;

FIG. 6(A)-FIG. 6(C) are first diagrams showing examples of a histogram of a human region moving image according to a first embodiment of the present invention;

FIG. 7(A)-FIG. 7(C) are second diagrams showing examples of a histogram of a human region moving image according to a first embodiment of the present invention;

FIG. 8(A)-FIG. 8(C) are third diagrams showing examples of a histogram of a human region moving image according to a first embodiment of the present invention;

FIG. 9 is a diagram showing an example of a personal behavior table according to a first embodiment of the present invention;

FIG. 10 is a diagram showing an example of a specific person table according to a first embodiment of the present invention;

FIG. 11 is a diagram showing an example of a surveillance image according to a first embodiment of the present invention;

FIG. 12 is a block diagram showing the composition of a surveillance system according to a second embodiment of the present invention;

FIG. 13 is a block diagram showing the composition of a recording section according to a second embodiment of the present invention;

FIG. 14 is a block diagram showing the composition of a detecting section according to a second embodiment of the present invention;

FIG. 15 is a block diagram showing the composition of a surveillance system according to a third embodiment of the present invention;

FIG. 16 is a block diagram showing the composition of a recording section according to a third embodiment of the present invention;

FIG. 17 is a block diagram showing the composition of a transmitting/receiving section according to a third embodiment of the present invention;

FIG. 18 is a block diagram showing the composition of a detecting section according to a third embodiment of the present invention;

FIG. 19 is a block diagram showing the composition of a database section according to a third embodiment of the present invention;

FIG. 20 is a block diagram showing the composition of an identifying section according to a third embodiment of the present invention;

FIG. 21 is a block diagram showing the composition of a surveillance system according to a fourth embodiment of the present invention;

FIG. 22 is a block diagram showing the composition of a transmitting/receiving section according to a fourth embodiment of the present invention;

FIG. 23 is a block diagram showing the composition of a recording section according to a fourth embodiment of the present invention;

FIG. 24 is a block diagram showing the composition of a database section according to a fourth embodiment of the present invention;

FIG. 25 is a block diagram showing the composition of a surveillance system according to a fifth embodiment of the present invention; and

FIG. 26 is a block diagram showing the composition of a database section according to a fifth embodiment of the present invention.

### DESCRIPTION OF THE PREFERRED EMBODIMENTS

Below, embodiments of the present invention are described with reference to the drawings.

FIG. 1 is a block diagram showing the composition of a surveillance system according to a first embodiment of the present invention.

(First Embodiment)

As shown in FIG. 1, the surveillance system 1-A comprises: a recording section 11, which is connected to a recording section 2 for recording surveillance images captured by a surveillance camera 10 for capturing a surveillance position, and which receives surveillance images captured by the surveillance camera 10 from the recording section 2, recognizes human actions on the basis of the basis of these images, and records the corresponding results; an identifying section 21 for identifying a person to be detected, from the results in the recording section 11; and a detecting section 31 for detecting a specific person from the surveillance images and the recognition results of the identifying section 21.

Here, the surveillance camera 10 generally employs an industrial surveillance camera, but it is also possible to use another type of camera, such as a broadcast video camera, or domestic video camera, or the like, provided that it comprises a function for capturing moving images as surveillance images.

A surveillance camera 10 of this kind is installed, for example, in commercial premises, such as convenience stores, supermarkets, department stores, home centers, shopping centers, and the like, financial establishments, such as banks, savings banks, and the like, transport facilities, such as railway stations, railway carriages, underground railways, buses, aeroplanes, and the like, amusement facilities, such as theatres, theme parks, amusement parks, playgrounds, and the like, accommodation facilities, such as hotels, guesthouses, and the like, eating establishments, such as dining halls, restaurants, and the like, public premises, such as schools, government offices, and the like, housing premises, such as private dwellings, communal dwellings, and the like, interior areas of general buildings, such as entrance halls, elevators, or the like, work facilities, such as construction sites, factories, or the like, and other facilities and locations.

The present embodiment is described with reference to an example wherein a surveillance camera 10 is installed in a store, such as a convenience store.

Firstly, the recording section 11 is described.

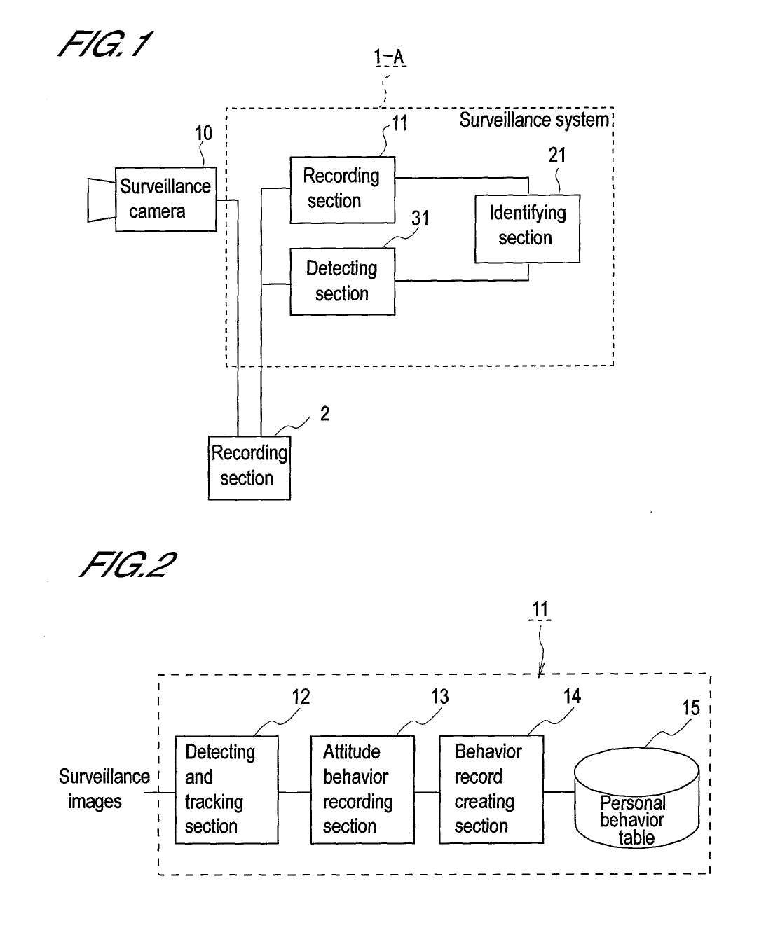

FIG. 2 is a block diagram showing the composition of a recording section in a first embodiment of the present invention.

As shown in FIG. 2, the recording section 11 comprises a detecting and tracking section 12 for detecting and tracking respective persons from surveillance images captured by the surveillance camera 10, an attitude and behavior recognising section 13 for recognising the attitude and behavior of the respective persons detected and tracked, a behavior record creating section 14 for creating and recording information relating to the attitudes and actions of respective characters, and a personal behavior table 15. The recording section 11 records the information relating to the actions of the respective persons as created by the behavior record creating section 14, in the personal behavior table 15.

Next, the identifying section 21 is described.

FIG. 3 is a block diagram showing the composition of an identification section according to a first embodiment of the present invention.

As shown in FIG. 3, the identifying section 21 comprises an input/output section 23 for performing input of characteristic feature information for a person who is to be identified, and output of search results, a specific person searching section 22 for searching for a person matching the characteristic feature information for the person to be identified, from the personal behavior table 15, and a specific person table 24. The identifying section 21 records the characteristic features of the person to be identified as found by the specific person searching section 22, in the specific person table 24.

Next, the detecting section 31 is described.

FIG. 4 is a block diagram showing the composition of a detecting section according to a first embodiment of the present invention.

As shown in FIG. 4, the detecting section 31 comprises a specific person detecting section 32 for detecting a person recorded in the specific person table 24, from a surveillance image, and a detection result outputting section 33 for displaying the result of the specific person detecting section 32.

Moreover, the surveillance system 1-A is connected to a recording section 2 which records the surveillance image captured by the surveillance camera 10. The present embodiment is described with respect to an example where a video tape recorded is used as the recording section 2, but it is also possible to adopt various other types of recording means, instead of a video tape recorder, such as a semiconductor memory, magnetic disk, magnetic tape, optical disk, magneto-optical disk, or the like. Moreover, the recording section 22 may store data, such as the personal behavior table 15 created by the behavior record creating section 14, and the specific person table 24, or the like, in addition to the surveillance images captured by the surveillance camera 10. Furthermore, in the present embodiment, the recording section 2 is constituted independently from the surveillance system 1-A, but in recent years, computers capable of recording moving images on a hard disk has started to proliferate, and by using a computer of this kind, it is possible to adopt a composition where the recording section 2 is incorporated into the surveillance system 1-A. A composition of this kind is described in the third to fifth embodiments.

Furthermore, the surveillance system 1-A in this embodiment comprises a display section (not illustrated). This display section has a display screen, such as a CRT, liquid crystal display, plasma display, or the like, and displays the personal behavior table 15, specific person table 24, and the like, created by the behavior record creating section 14. Here, the display section displays images captured by a surveillance camera 10, but it may also display other images. Moreover, the display section may be a unit other than a personal computer, such as a television receiver. In this case, the surveillance system 1-A sends an image signal to this unit, and the personal behavior table 15, specific person table 24, and the like, are displayed thereon. The images displayed by the display section may be moving images or still images.

Next, the operation of the surveillance system 1-A according to the present embodiment will be described. The recording section 11, identifying section 21 and detecting section 31 of the surveillance system 1-A are able to manage the number of frames of the surveillance image recorded in the recording section 2 and to cause the recording section 2 to output the surveillance images of a prescribed region.

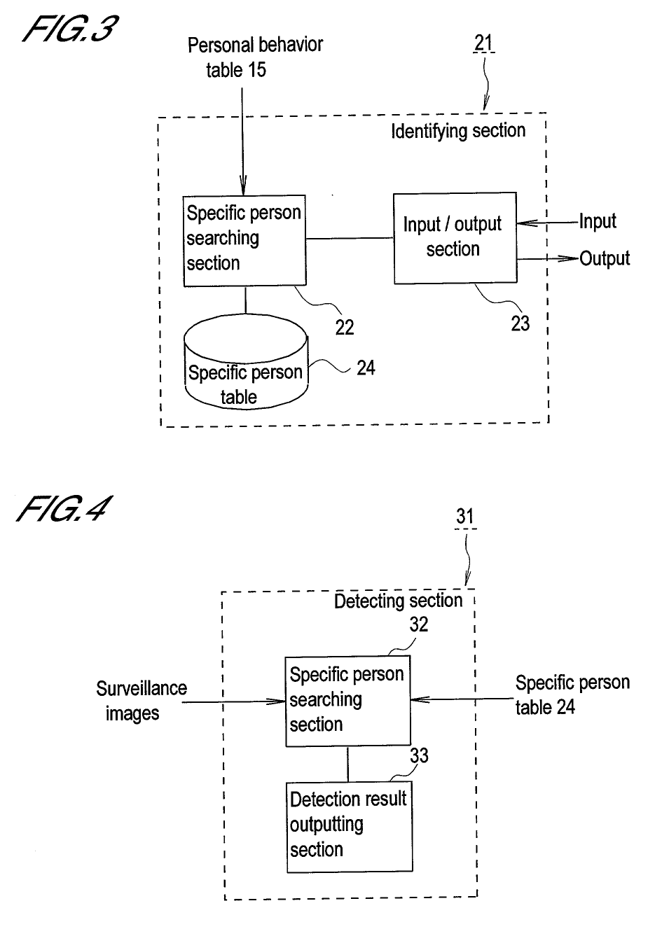

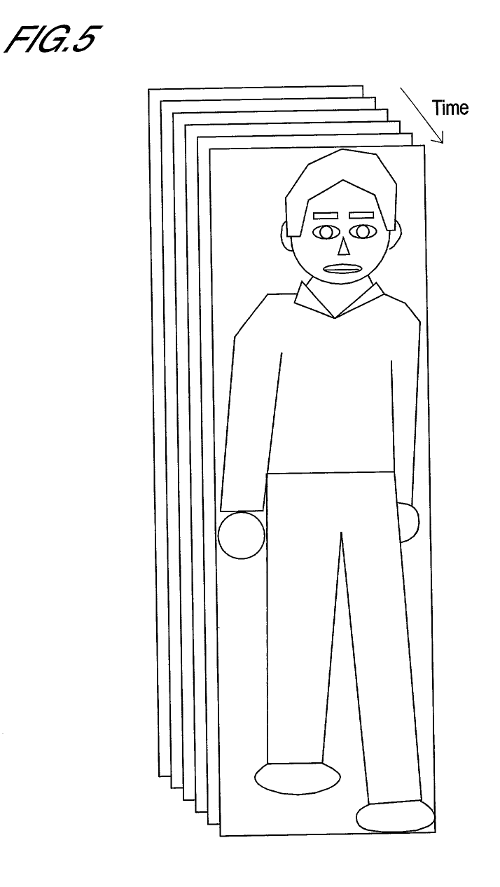

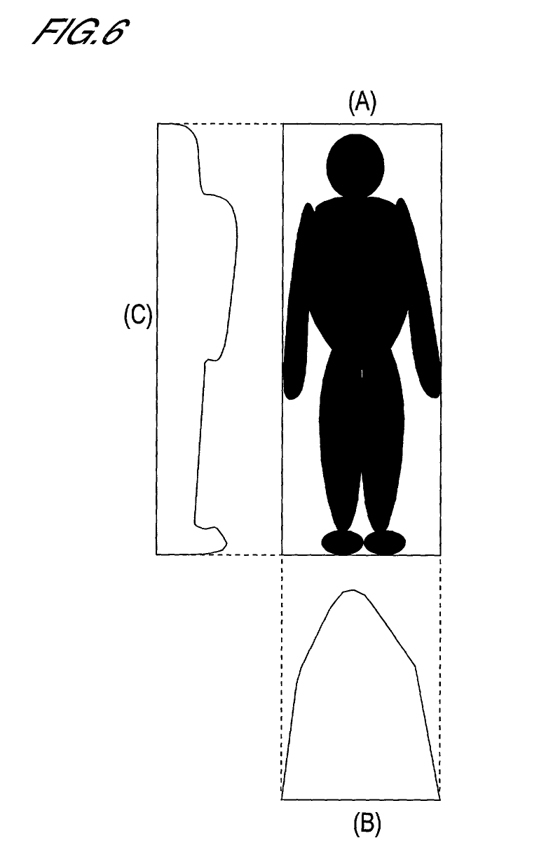

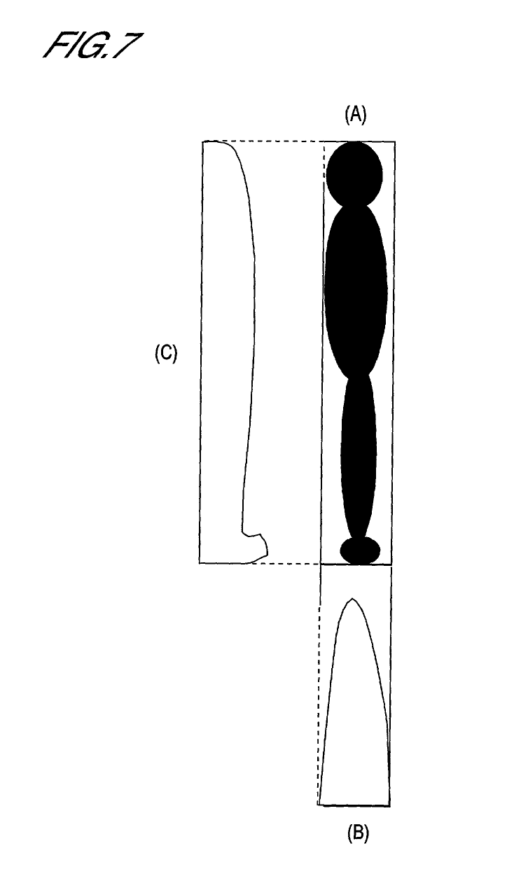

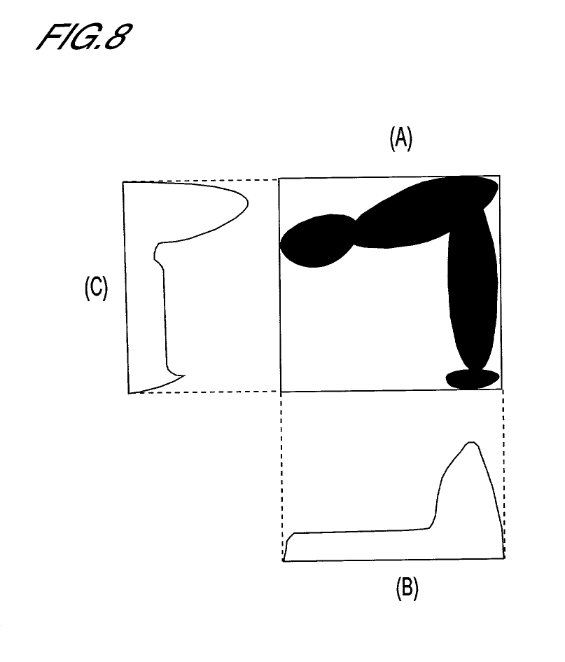

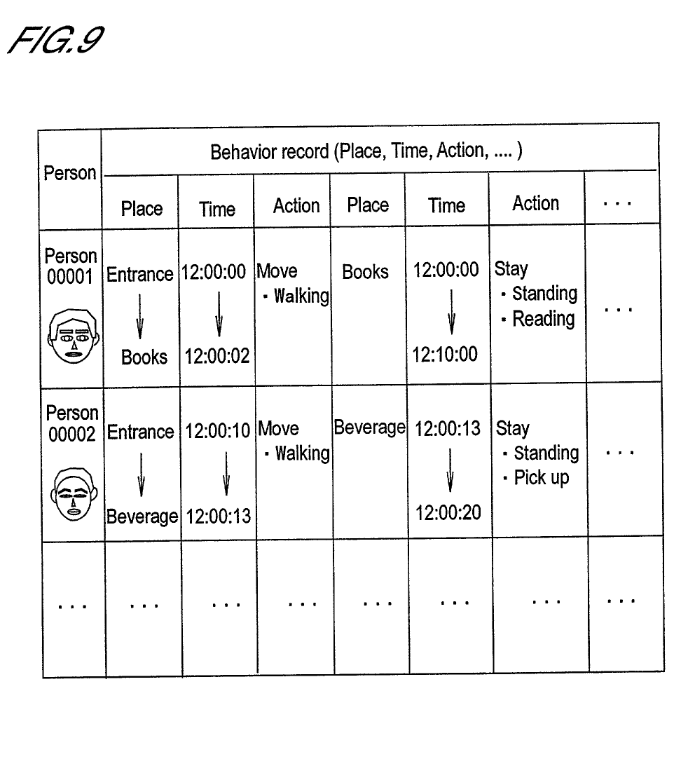

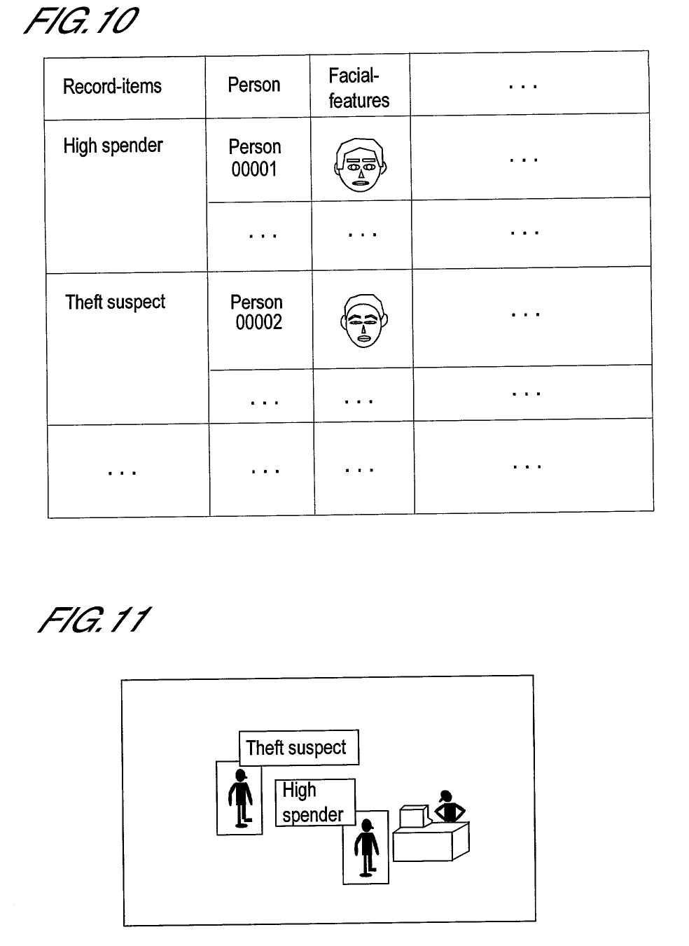

FIG. 5 shows an example of a moving image of a human region of the image in a first embodiment of the present invention. FIG. 6(A) to FIG. 6(C) are first diagrams showing examples of projection histograms of the human region in a first embodiment of the present invention; FIG. 7(A) to FIG. 7(C) are second diagrams showing examples of projection histograms of the human region in a first embodiment of the present invention; FIG. 8(A) to FIG. 8(C) are third diagrams showing examples of projection histograms of the human region in a first embodiment of the present invention; FIG. 9 shows an example of a personal behavior table in a first embodiment of the present invention; FIG. 10 shows an example of a specific person table in a first embodiment of the present invention; and FIG. 11 shows an example of a surveillance image based on a surveillance system according to a first embodiment of the present invention.

Firstly, the operation of the recording section 11 will be described.

The recording section 11 receives images of a location that is to be observed, as captured by a surveillance camera 10, from the recording section 2. Thereby, the recording section 11 recognizes the attitude or actions of respective persons in the moving images, and records this information in the personal behavior table 15.

Thereupon, the detecting and tracking section 12 firstly performs detection and tracking processing of the persons depicted in the surveillance images received from the surveillance camera 10. The detecting and tracking section 12 derives a moving image which extracts the region depicting a person from the surveillance image (hereinafter, called “human region moving image”), and it sends the human travel path information obtained therefrom to the attitude and behavior recognizing section 13.

In implementing the present invention, various types of method can be employed to carry out this person detection and tracking processing. For example, in a commonly known technique, a moving object is detected by using the movement information of the optical flow between consecutive frames of a moving image, and detection and tracking of persons is carried out on the basis of the characteristic features of that movement, but although this method may be used, in the present embodiment, a differential segmentation processing technique is adopted, as described below.

The detecting and tracking section 12 firstly extracts a region of change by performing a differential segmentation processing between a background image where no person is depicted and an input image. Thereupon, person detection is carried out by using characteristic quantities, such as the shape, size, texture, and the like, of the region of change, to determine whether or not the region of change is a person. Subsequently, the detecting and tracking section 12 tracks the human region by creating an association between the change regions in consecutive frames of the moving image, on the basis of the characteristic quantities.

By means of person detection and tracking processing of this kind, the detecting and tracking section 12 extracts the human region moving image for a particular person from the surveillance images, as illustrated in FIG. 5, and thereby is able to obtain travel path information for that person (for example, the path of travel of the center of gravity of the human region in the surveillance image). The detecting and tracking section 12 sends this human region moving image and travel path information to the attitude and behavior recognizing section 13.

The attitude and behavior recognizing section 13 receives the human region moving image and travel path information from the detecting and tracking section 12 and performs recognition of the attitude and behaviors of the person on the basis thereof. In other words, the attitude and behavior recognizing section 13 first determines whether the person is moving or is stationary, on the basis of the travel path information, and then performs recognition of the attitude and behaviors of the person according to his or her respective state.

Here, if the person is moving, the attitude and behavior recognizing section 13 derives, at the least, movement start position information and end position information, and movement start time information and end time information. The movement start position information is the position of the person in the surveillance image when the action of the person changed from a stationary state to a moving state, or, if the person has entered into the scene, it is the position at which the person is first depicted in the surveillance image.

In addition to the movement start position information and end position information, and the movement start time information and end time information, the attitude and behavior recognizing section 13 may also derive a classification indicating whether the movement is walking or running, on the basis of the speed of movement, or it may derive action information during movement. Furthermore, the attitude and behavior recognizing section 13 may also further divide the classifications indicating a walking movement or running movement, for example, into walk 1, walk 2, . . . , run 1, run 2, . . . , and so on. Here, the “movement end position information” is the position of the person in the surveillance image when the action of the person changes from a moving state to a stationary state, or the position at which the person in the moving image was last depicted, in a case where the person has exited from the scene. Furthermore, the action information during movement is a recognition result derived by the attitude and behavior recognizing section 13 using a recognition technique as described below, or the like.

If the person is stationary, then the attitude and behavior recognizing section 13 derives halt position information, halt time information, attitude information and action information. The halt position information represents the position of a person who continues in a stationary state in the moving image. This halt position information coincides L with the movement end position information. The halt time information indicates the time period for which the person continues in a stationary state. The attitude information indicates the attitude of the person as divided into four broad categories: “standing attitude”, “bending attitude”, “sitting attitude”, and “other attitude”. However, in addition to the three attitudes “standing attitude”, “bending attitude”, and “sitting attitude”, it is also possible to add a “lying attitude” and “supine attitude”, according to requirements.

Here, the shape characteristics of the human region are used as a processing technique for deriving the attitude information. In the present embodiment, three characteristics are used, namely, the vertical/horizontal ratio of the external perimeter rectangle of the human region, the X-axis projection histogram of the human region, and the Y-axis projection histogram of the human region.

In general, if a person in “standing attitude” is captured from the front, then the vertical/horizontal ratio of the external rectangle, which is the ratio between the vertical and horizontal sides of the rectangular box which contacts the perimeters of the human region of that person, will be as shown in FIG. 6(A), the X-axis projection histogram, which is the projection of the human region in the vertical direction, will be as shown in FIG. 6(B), and the Y-axis projection histogram, which is the projection of the human region in the horizontal direction, will be as shown in FIG. 6(C).

Furthermore, if a person in “standing attitude” is captured from the side, then the vertical/horizontal ratio of the external rectangle of the human region for that person will be as shown in FIG. 7(A), the X-axis projection histogram, which is the projection of the human region in the vertical direction, will be as shown in FIG. 7(B), and the Y-axis projection histogram, which is the projection of the human region in the horizontal direction, will be as shown in FIG. 7(C).

Moreover, if a person in “bending attitude” is captured form the side, then the vertical/horizontal ratio of the external rectangle of the human region for that person will be as shown in FIG. 8(A), the X-axis projection histogram, which is the projection of the human region in the vertical direction, will be as shown in FIG. 8(B), and the Y-axis projection histogram, which is the projection of the human region in the horizontal direction, will be as shown in FIG. 8(C).

In this way, the vertical/horizontal ratio of the external rectangle of the human region, the X-axis projection histogram, and the Y-axis projection histogram have different characteristics, depending on the attitude of the person. Therefore, the attitude and behavior recognizing section 13 is able to recognize the attitude of the person on the basis of the vertical/horizontal ratio of the external rectangle of the human region, the X-axis projection histogram, and the Y-axis projection histogram. In other words, the attitude and behavior recognizing section 13 previously stores vertical/horizontal ratios of the external rectangle of the human region, X-axis projection histograms, and Y-axis projection histograms corresponding to respective attitudes, as attitude recognition models, in its own memory region, and it compares the shape of a person depicted in the human region of the surveillance image with the shapes of the attitude recognition models. Thereby, the attitude and behavior recognizing section 13 is able to recognize the attitude of the person depicted in the surveillance image.

As illustrated in FIG. 6 and FIG. 7, even for the same attitude, the attitude recognition model varies in terms of the vertical/horizontal ratio of the external rectangle of the human region, and the shape of the X-axis projection histogram and the Y-axis projection histogram, depending on the orientation of the person. Therefore, the attitude and behavior recognizing section 13 stores attitude recognition models for respective orientations, in its memory region. Since an attitude and behavior recognizing section 13 of this kind is able to recognize the orientation of the person, in addition to the person's attitude, then it is capable of sending information relating to the orientation, in addition to the attitude information, to the subsequent behavior record creating section 14.

Thereupon, the attitude and behavior recognizing section performs behavior recognition processing.

Firstly, the attitude and behavior recognizing section 13 detects the upper body region of the person, using the attitude information obtained in the attitude recognition processing step and the shape characteristics of the human region used in order to obtain this attitude information. The attitude and behavior recognizing section 13 then derives the actions of the person in the upper body region. Here, a method for deriving this information is used wherein the image of the human region is compared with a plurality of previously stored template images, using gesture-specific spaces, and the differentials therebetween are determined, whereupon the degree of matching of the upper body region, such as the arms, head, and the like, is calculated on the basis of the differentials (see Japanese Patent Laid-open No. (Hei)10-3544). Thereby, the attitude and behavior recognizing section 13 is able to derive the actions of the upper body region of the person, and in particular, the person's arms. An action which cannot be derived by this technique is classified as “other action”.

Next, the attitude and behavior recognizing section 13 identifies the behavior of the person on the basis of the person's attitude and the person's location. More specifically, by narrowing the search according to the attitude and location, it identifies what kind of behavior the derived action implies.

In other words, since the range of view captured by the surveillance camera 10 is previously determined, the attitude and behavior recognizing section 13 is able to identify the location at which a person is performing an action, on the basis of that range and the movement start position and end position of the person. Thereby, the attitude and behavior recognizing section 13 can identify the behavior of the person by recognizing the attitude and actions of the person. For example, in the case of a store, such as a convenience store, the attitude and behavior recognizing section 13 is able to identify behavior whereby the person walks from the entrance of the store to a book section where books and magazines are sold, and behavior whereby the person stands reading in the book section, and the like.

In this way, the attitude and behavior recognizing section 13 performs attitude and behavior recognition for each person depicted in the surveillance images, on the basis of the human region moving image and the travel path information received from the detecting and tracking section 12, and is able to obtain a recognition result, such as “when”, “where”, “what action”, for each person detected. Thereupon, the attitude and behavior recognizing section 13 sends the recognition results for the person's attitude and behavior, and the human region moving image, to the behavior record creating section 14.

The behavior record creating section 14 creates a personal behavior table 15 such as that illustrated in FIG. 9, for example, on the basis of the recognition results for the person's attitude and behavior, and the human region moving image, received from the attitude and behavior recognizing section 13. The personal behavior table 15 describes information such as “when”, “where”, “what” for each person detected, in the form of text data. The behavior record creating section 14 records information of the kind described above in the personal behavior table 15, each time the location or behavior of the person changes. The personal behavior table 15 is not limited to the format illustrated in FIG. 9, and may be created in any desired format.

The behavior record creating section 14 is able to record the location at which a certain person is performing his or her behavior, in the personal behavior table 15, obo the recognition results from the attitude and behavior recognizing section 13. Moreover, the behavior record creating section 14 is also able to record the timing and elapsed time for which a certain person has been in a particular location, whilst also recording the behavior of that person, by means of the movement start timing and end timing. For example, in the case of a store, such as a convenience store, the behavior record creating section 14, as shown in FIG. 9, is able to record in the personal behavior table 15 the fact that person 00001 moved from the store entrance to the book section selling books and magazines, as well as recording the timings and elapsed time for which the person was in respective locations, and the behavior of the person in those respective locations.

Here, the recorded elements indicating location, behavior, and the like, in the personal behavior table 15 are recorded in the form of text data which can be edited and processed. Therefore, the personal behavior table 15 can be used for various applications, by subsequently editing and processing it according to requirements. For example, the personal behavior table 15 can be used for applications such as readily finding prescribed record items by means of a keyword search, classifying record items by means of a prescribed perspective, or creating statistical data, or the like.

The format in which the record items are recorded is not limited to text data, and any format may be used for same, provided that it permits editing and processing. Moreover, it is also possible to adopt a format wherein not necessarily all of the record items are editable and processable.

According to requirements, the behavior record creating section 14 detects the face region of the person from the human region moving image it receives. The behavior record creating section 14 then selects the most forward-orientated face image from the moving image, as illustrated in FIG. 9, and records face data indicating the characteristics of the person (hereinafter, called “facial features”) in the personal behavior table 15 as a type of record item. The behavior record creating section 14 is able to record the facial features in the form of image data, as shown in FIG. 9, but it may also record them in the form of text data which expresses characteristics, such as facial shape, expression, and the like, in words, such as “round face, long face, slit eyes”, and the like. Furthermore, the behavior record creating section 14 is able to create a face image table which creates an association for the face image of a person.

In this way, as illustrated in FIG. 9, the behavior record creating section 14 records information, such as “when”, “where”, “what action” for each person in the surveillance image within the range of surveillance, in the personal behavior table 15 as text data, and it also records the face image of each person therein.

The format in which the record items are recorded in the personal behavior table 15 is not limited to text data, and any format may be adopted, provided that it permits searching of the contents of the personal behavior table 15. Moreover, with regard to the contents recorded in the personal behavior table 15, it is not necessary to record all of the items all of the time, but rather, record items, such as the “what action” information, for example, may be omitted, depending on the circumstances.

Moreover, with regard to the recorded face images, it is possible to select and record only the forward-orientated face image, but it is also possible to record all face images. Furthermore, in addition to the face images, full-body images of each person may be recorded in conjunction therewith.

In this way, the recording section 11 continues to record the behavior, face image, full-body image, and the like, of each person in the image, in the personal behavior table 15, as long as surveillance images continue to be input from the surveillance camera 10.

When the recording section 11 has recorded the behavior of persons in the personal behavior table 15 for a prescribed number of persons or more, or for a prescribed time period or more, the information for a person who is to be investigated is sent to the identifying section 21.

The identifying section 21 inputs the information for a person to be investigated, via the input/output section 23. The identifying section 21 then searches the personal behavior table 15 for a person of matching information, by means of a specific person searching section 22.

Next, the overall operation of the surveillance system will be described. Here, the description relates to the operation in the case of detecting a person who may possibly have committed theft, in other words, a theft suspect.

Firstly, the surveillance operator identifies a product that has been stolen, obo the product stock status and sales information, and the like, and then estimates the time at which it is thought that the product was stolen.

The surveillance operator is a person who operates the surveillance system, and may be, for example, a shop assistant, the store owner, a security operator, or the like.

In this case, the time at which it is thought that the product was stolen, in other words, the estimated time of theft, is specified in terms of X o'clock to Y o'clock, for example. The surveillance operator then inputs, via the input/output section 23, search criteria in order to search for persons who approached the area in which the product was displayed within the estimated time of theft.

The specific person searching section 22 then accesses the personal behavior table 15, and searches the record items in the personal behavior table 15 according to the search criteria. Thereby, the specific person searching section 22 finds theft suspects. The specific person searching section 22 outputs these results to a display section (not illustrated), via the input/output section 23.

If a plurality of suspects are found as a result of the search, then the surveillance operator specifies further search criteria, such as the display location and time of a product which may possibly have been stolen on another day, and conducts a search using an “and” condition. Thereby, the surveillance operator is able to narrow the range of suspects. The surveillance operator is also able to narrow the range of suspects by referring to the overall store visiting records of the suspects found by the first search. In this way, the surveillance operator is able to identify a specific person as a theft suspect.

Depending on the manner of application, in addition to theft suspects, the surveillance operator is also able to search for and identify specific persons who have a high average spend amount, or persons who tend to buy a specific type of product.

In this case, the specific person searching section 22 stores the reason for identifying the specific person in the specific person table 24 as an item by which the specific persons are classified, as illustrated in FIG. 10.

In this way, the specific person searching section 22 is able to write the record items of the specific person found by means of the various conditions as a final result in the specific person table 24. As illustrated in FIG. 10, for each criteria used to classify the specific persons, the specific person table 24 stores the record items of the specific persons who match that criteria. Here, the information of the specific persons recorded as record items in the specific person table 24 may be extracted from the record items in the personal behavior table 15. Moreover, the information of the specific persons recorded as record items in the specific person table 24 may also be text data which describes in words the characteristic quantities of the face image and full-body image obtained by analyzing the full image, full-body image, and the like recorded as record items in the personal behavior table 15.

The surveillance operator is able to write the information of a specific person directly to the specific person table 24 by means of the input/output section 23, and is also able directly to delete record items written to the specific person table 24.

In this way, the identifying section 21 searches the record items of the personal behavior table 15 in accordance with the search criteria, and identifies a specific person. It then writes the information for the specific person thus identified to the specific person table 24, as record items.

Thereupon, the detecting section 31 detects the specific person written to the specific person table 24 from the surveillance images.

Firstly, the specific person detecting section 32 detects and tracks the human region from the surveillance images, similarly to the detecting and tracking section 12 of the recording section 11. The specific person detecting section 32 then investigates whether or not the characteristics of the human region thus detected match the characteristics of the specific person written to the specific person table 24. For example, if the face image of a specific person is written to the specific person table 24 as a characteristic of the specific person, then the specific person detecting section 32 compares the face image in the specific person table 24 with the face image in the human region of the surveillance image to judge whether or not they are matching.

If it is judged that the face image in the specific person table 24 does match the face image in the human region of the surveillance image, then the detecting section 31 outputs the surveillance image, along with the item classifying the specific person in question, for example, an item indicating that the person is a theft suspect, or a high spender, or the like, as a detection result, to a display section (not illustrated) via the detection result outputting section 33. The detection result can be displayed on the surveillance image in the form of an attached note indicating the item by which the detected person is classified, as illustrated in FIG. 11, and it may also be output in the form of a voice, warning sound, or the like, or furthermore, the foregoing can be combined.

In this way, in the surveillance system 1-A according to the present embodiment, the recording section 11 records the behavior of respective persons in a personal behavior table 15, the identifying section 21 searches for a person who is to be identified, such as a theft suspect, from the surveillance images, obo the record items in the personal behavior table 15, and writes the record items of a specific person to the specific person table 24 for each item by which the specific persons are classified, and the detecting section 31 detects a specific person obo the record items in the specific person table 24.

Therefore, the surveillance system 1-A performs a search obo the record items in the personal behavior table 15, whenever a search item is input, and hence it is able to search for and identify specific persons, such as theft suspects, with a high degree of accuracy.

Moreover, simply by means of the surveillance operator inputting search items, the surveillance system 1-A is able to search for and identify specific persons with a high degree of accuracy, and the detecting section 31 is able to detect a specific person obo the record items in the specific person table 24. Therefore, the surveillance operator is not required to verify a suspect by observing the surveillance images, and furthermore, he or she is not required to specify the human region of the surveillance image in order to indicate the region of a specific person, and hence the surveillance system 1-A is able to reduce the workload on the observer and to make energy savings.

Moreover, in a conventional surveillance system, it has been possible simply to detect a suspect, but the surveillance system 1-A not only detects suspects, but is also able to detect customers who correspond to other types of information, for instance, information such as purchasing tendencies, average spend amount, and the like. Consequently, the surveillance system 1-A is able to provide new services corresponding to respective customers. For example, in a bank, hotel, or the like, by detecting VIP users, a special service directed at VIP users can be offered (whereby, for instance, they do not have to stand in the normal queue), and in the case of a video rental store, book store, or the like, a service can be offered whereby new product information which matches the preferences of a visiting customer is broadcast in the store.

(Second Embodiment)

Below, a second embodiment of the present invention is described. Similar operations and elements having the same structure as the first embodiment are omitted from the following description.

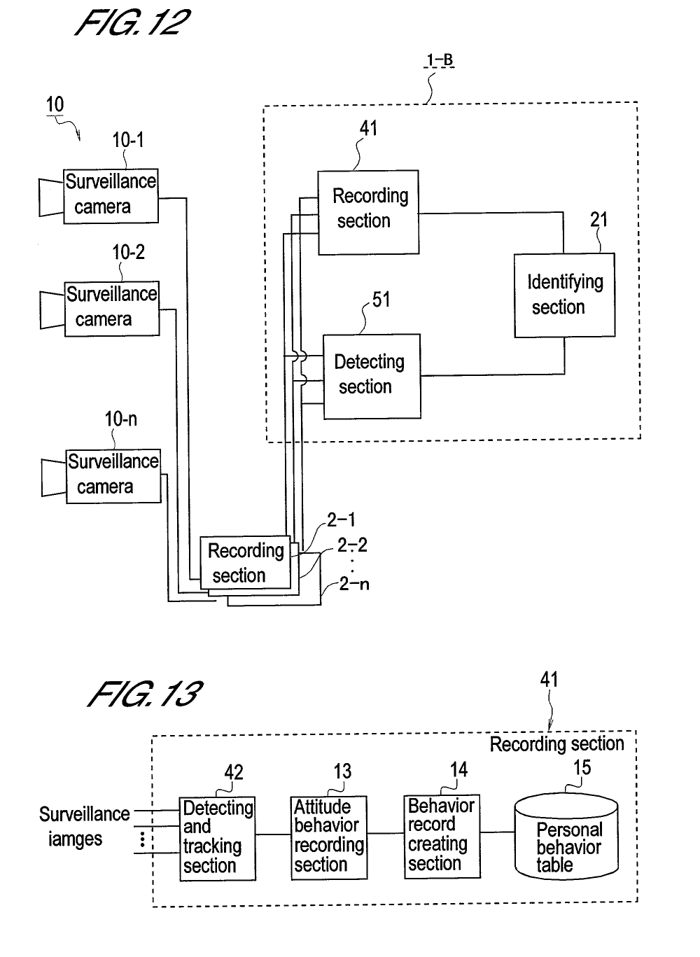

FIG. 12 is a block diagram showing the composition of a surveillance system according to a second embodiment of the present invention, FIG. 13 is a block diagram showing the composition of a recording section in a second embodiment of the present invention, and FIG. 14 is a block diagram showing the composition of a detecting section in a second embodiment of the present invention.

The first embodiment described a case where only one surveillance camera 10 is used, but in the present embodiment, a plurality of surveillance cameras 10 are used in order to capture three-dimensional images of people. In this case, the surveillance cameras 10 are constituted by a plurality of surveillance cameras 10-1, 10-2, . . . , 10-n. By capturing images of the same location by means of the plurality of surveillance cameras 10-1, 10-2, . . . , 10-n, a person in the surveillance image can be tracked three-dimensionally, and by capturing images of different locations by means of the surveillance cameras 10-1, 10-2, . . . , 10-n, and by tracking persons over a broad range, it is possible to obtain a larger amount of information for respective persons.

The surveillance system 1-B according to the present embodiment comprises a recording section 41 for recognizing and recording the behavior of persons from surveillance images captured by a plurality of surveillance cameras 10-1, 10-2, . . . , 10-n for capturing images of surveillance locations, an identifying section 21 for identifying a specific person to be detected from the results of the recording section 41, and a detecting section 51 for detecting a specific person from the surveillance image and the results of the identifying section 21. The surveillance system 1-B is also connected to recording section 2-1, 2-2, . . . , 2-n, which record surveillance images captured by the surveillance cameras 10-1, 10-2, . . . , 10-n.

As illustrated in FIG. 13, the recording section 41 comprises a detecting and tracking section 42 for detecting and tracking respective persons, three-dimensionally, from the surveillance images captured by a plurality of surveillance cameras 10-1, 10-2, . . . , 10-n.

As illustrated in FIG. 14, the detecting section 51 comprises a specific person detecting section 52 for detecting persons recorded in the specific person table 24 from the surveillance images captured by the plurality of surveillance cameras 10-1, 10-2, . . . , 10-n.

Next, the operation of the surveillance system 1-B will be described.

The recording section 41, identifying section 21 and detecting section 51 of the surveillance system 1-B are able to manage the number of frames of respective surveillance images stored in the recording section 2-1, 2-2, . . . 2-n, whereby control is implemented in such a manner that a plurality of surveillance images of the same scene are recognized synchronously, or surveillance i mages for a prescribed scene are output to the recording sections 2-1, 2-2, . . . , 2-n.

Firstly, the surveillance system 1-B sends the surveillance images captured from different angles by the plurality of surveillance cameras 10-1, 10-2, . . . , 10-n to the detecting and tracking section 42 of the recording section 41, from the recording sections 2-1, 2-2, . . . , 2-n. Thereupon, the detecting and tracking section 42 performs detection and tracking of persons using the images captured from different angles (see Technical Report of IEICE, PRMU99-150 (November 1999) “Stabilization of Multiple Human Tracking Using Non-synchronous Multiple Viewpoint Observations”).

Thereupon, once persons have been detected, the surveillance system 1-B recognizes the attitude and behavior of respective persons, by means of an attitude and behavior recognizing section 13, and a behavior record creating section then records the behavior record for the respective persons in a personal behavior table 15. In this case, a plurality of face images or full-body images captured from different directions are recorded in the personal behavior table 15.

The identifying section 21 carries out similar processing to that in the first embodiment. However, the personal data in the specific person table 24 is a recording of face images captured from different angles.

The detecting section 51 performs detection of specific persons from the surveillance images captured from different angles, by using the personal data in the specific person table 24.

In this way, the present embodiment is able to obtain information for respective persons from surveillance images captured at different angles by a plurality of surveillance cameras 10-1, 10-2, . . . , 10-n, and therefore detection of specific persons can be carried out to a higher degree of precision than in the first embodiment.

(Third Embodiment)

Below, a third embodiment of the present invention is described. Similar operations and elements having the same structure to the first and second embodiments are omitted from the description.

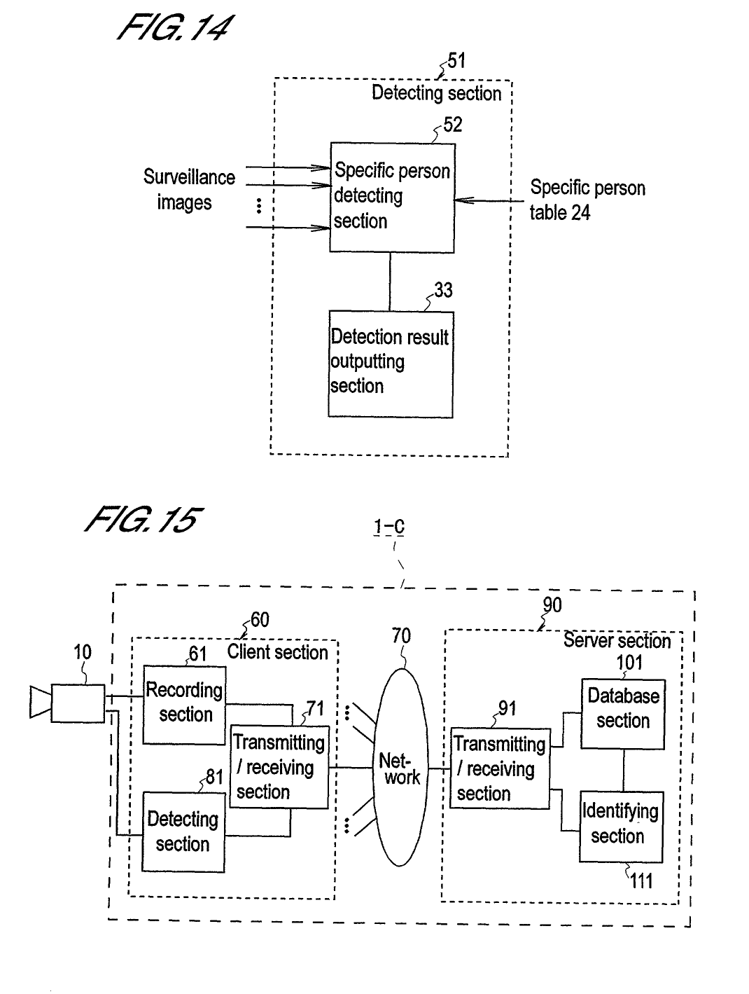

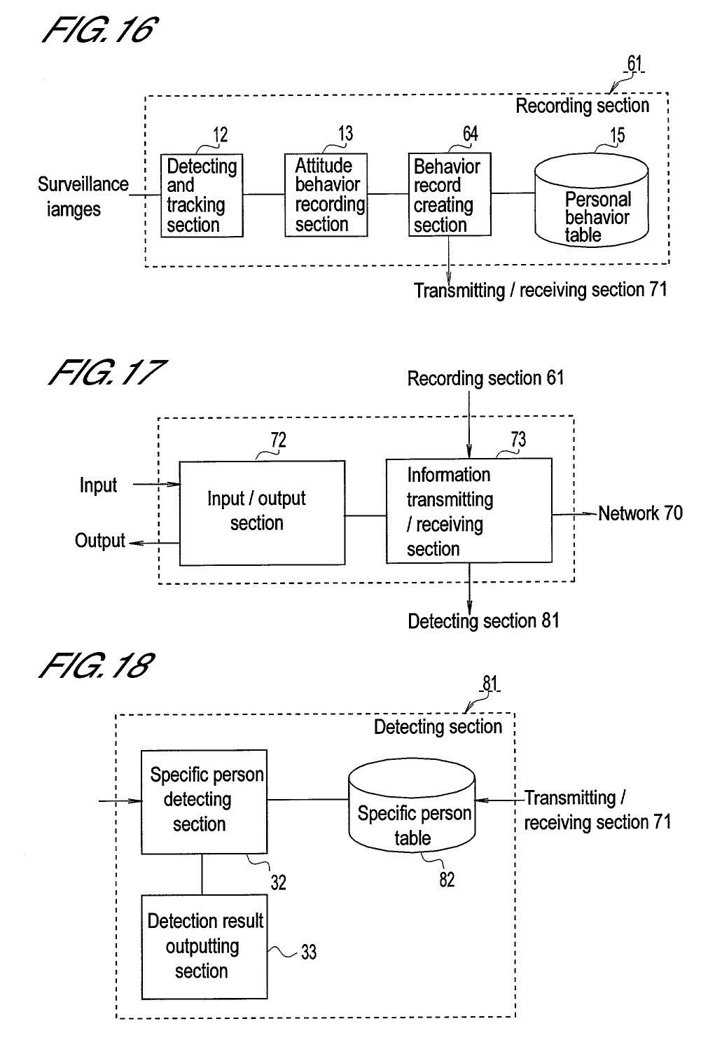

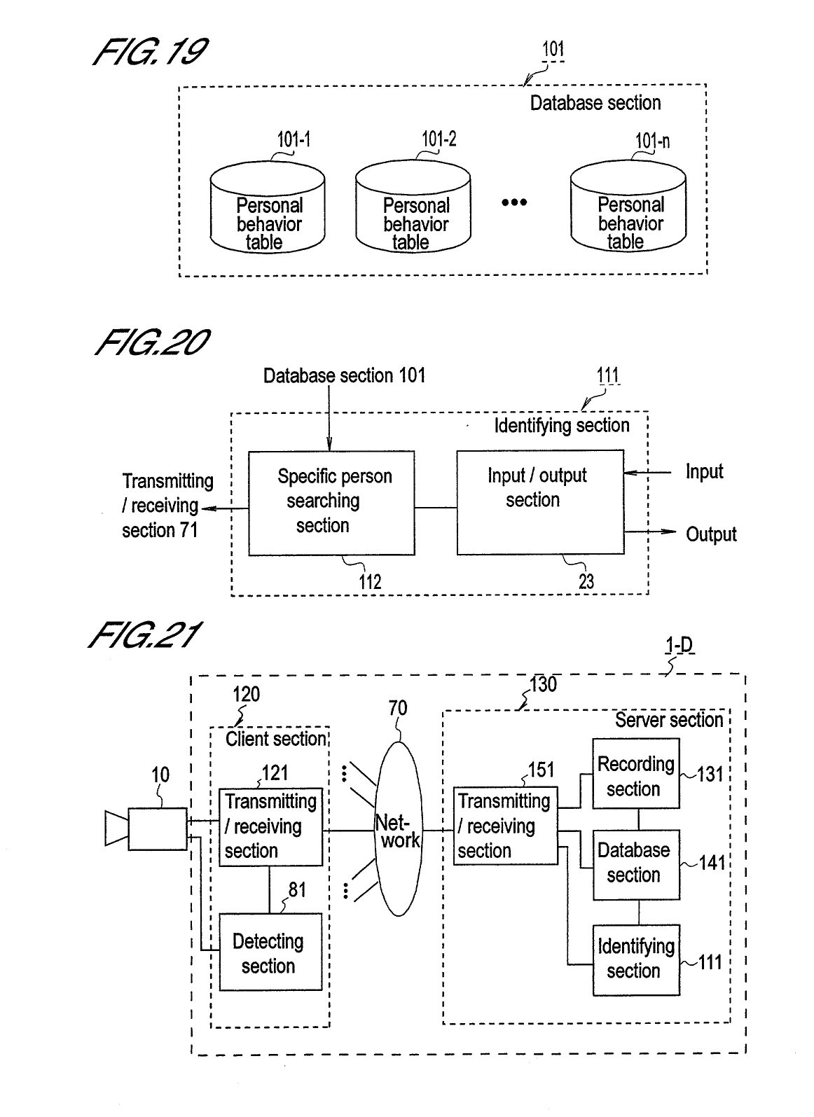

FIG. 15 is a block diagram showing the composition of a surveillance system according to a third embodiment of the present invention; FIG. 16 is a block diagram showing the composition of a recording section according to a third embodiment of the present invention; FIG. 17 is a block diagram showing the composition of a transmitting/receiving section according to a third embodiment of the present invention; FIG. 18 is a block diagram showing the composition of a detecting section according to a third embodiment of the present invention; FIG. 19 is a block diagram showing the composition of a database section according to a third embodiment of the present invention; and FIG. 20 is a block diagram showing the composition of an identifying section according to a third embodiment of the present invention.

The surveillance system 1-C according to this embodiment comprises client sections 60 consisting of a client terminal formed by a computer, and a server section 90 consisting of a server device formed by a computer.

In the present embodiment, the client sections 60 and server section 90 are described as devices which store moving images to a hard disk or a digital versatile disk (hereinafter, called “DVD”), which is one type of optical disk.

The client section 60 is a computer comprising: a computing section, such as a CPU, MPU, or the like; a recording section, such as a magnetic disk, semiconductor memory, or the like; an input section, such as a keyboard; a display section, such as a CRT, liquid crystal display, or the like; a communications interface; and the like. The client section 60 is, for example, a special device, personal computer, portable information terminal, or the like, but various other modes thereof may be conceived, such as a PDA (Personal Digital Assistant), portable telephone, or a register device located in a store, a POS (Point of Sales) terminal, a kiosk terminal, ATM machine in a financial establishment, a CD device, or the like.

Moreover, the server section 90 is also a computer comprising: a computing section, such as a CPU, MPU, or the like; a recording section, such as a magnetic disk, semiconductor memory, or the like; an input section, such as a keyboard; a display section, such as a CRT, liquid crystal display, or the like; a communications interface; and the like. The server section 90 is, for example, a generic computer, work station, or the like, but it may also be implemented by a personal computer, or other mode of device.

The server section 90 may be constituted independently, or it may be formed by a distributed server wherein a plurality of computers are coupled in an organic fashion. Moreover, the server section 90 may be constituted integrally with a large-scale computer, such as the host computer of a financial establishment, POS system, or the like, or it may be constituted as one of a plurality of systems built in a large-scale computer.

In the surveillance system 1-C, the client sections 60 and server section 90 are connected by means of a network 70, in such a manner that a plurality of client sections 60 can be connected to the server section 90. The network 70 may be any kind of communications network, be it wired or wireless, for example, a public communications network, a dedicated communications network, the Internet, an intranet, LAN (Local Area Network), WAN (Wide Area Network), satellite communications network, portable telephone network, CS broadcasting network, and the like. Moreover, the network 70 may be constituted by combining plural types of networks, as appropriate.

In the surveillance system 1-C, the server section 90 is assigned the function of the identifying section 21 described with respect to the first and second embodiments above, and it has a composition for performing universal management and processing of the information from a plurality of client sections 60.

In the surveillance system 1-C, as illustrated in FIG. 15, the client section 60 comprises a recording section 61, a transmitting/receiving section 71 forming a first transmitting/receiving section, and a detecting section 81, and the server section 90 comprises a transmitting/receiving section 91 forming a second transmission and receiving section, a database section 101 and an identifying section 111.

As illustrated in FIG. 16, the recording section 61 comprises a detecting and tracking section 12, an attitude and behavior recognizing section 13, a behavior record creating section 64, and a personal behavior table 15, and as illustrated in FIG. 17, the transmitting/receiving section 71 comprises an input/output section 72 and an information transmitting/receiving section 73. As shown in FIG. 18, the detecting section 81 comprises a specific person detecting section 32, a detection result outputting section 33, and a specific person table 82.

As shown in FIG. 19, the database section 101 comprises a plurality of personal behavior tables 101-1, 101-2, . . . , 101-n, and as shown in FIG. 20, the identifying section 111 comprises a specific person searching section 112 and an input/output section 23.

The client section 60 and server section 90 are also provided with recording sections (not illustrated), such as a hard disk, DVD, or the like, which are used to store surveillance images and other information.

Next, the operation of the surveillance system 1-C is described.

The surveillance system 1-C according to the present embodiment has a composition, as shown in FIG. 15, wherein the client sections 60 and server section 90 are connected by means of a network 70. The client sections 60 have the functions of the recording sections 11, 41, and the detecting sections 31, 51 in the first and second embodiments, and the server section 90 has the function of the identifying section 21. The client section 60 is normally distributed in a plurality of locations, for example, different retail outlets, or different sales locations of a large-scale retail outlet, or the like.

The general sequence of processing in a surveillance system 1-C of this kind is described below.

Firstly, the surveillance system 1-C sends the information for respective persons detected by the respective client sections 60 to the server section 90, where it is accumulated.

Thereupon, in the surveillance system 1-C, a certain client section 60 sends the server section 90 information for a person who is to be identified as a specific person, for example, a person who visited the book section between X o'clock and Y o'clock, or a person who may possibly have committed theft in the book section on the day x of month y, in other words, information for a theft suspect. The server section 90 identifies the suspect obo this information, and sends information about the suspect to the client section 60. Thereupon, the client section 60 detects the suspect from the surveillance images, obo the information about the suspect.

In this way, the surveillance system 1-C is able to perform more accurate identification of specific persons by gathering together the information sent by a plurality of client sections 60 situated in different locations, in a single server section 90, in order to identify a specific person. Moreover, when necessary, the surveillance system 1-C is able to detect the specific person also in other locations by sending information about a specific person who is to be detected by a certain client section 60, to a plurality of client sections 60.

Next, the operation of the client section 60 will be described.

Firstly, the recording section 61 performs processing that is virtually the same as that of the recording section 11 in the first embodiment. Here, the recording section 61 sends record items relating to the attitude, behavior, and the like, of respective persons in the images, as created by the behavior record creating section 64, not only to the personal behavior table 15, but also to the transmitting/receiving section 71. In this case, since the record items relating to the attitude, behavior, and the like, of respective persons in the images are also recorded in the server section 90, as described hereinafter, it is not necessary to include them in recording section 61.

The transmitting/receiving section 71 receives the behavior, face images, full-body images, and the like, of the respective persons in the images as sent by the recording section 61, by means of the information transmitting/receiving section 73.

The information transmitting/receiving section 73 has the function of processing the communication of information between the client section 60 and the server section 90, and sends record items it receives relating to the attitude, behavior, and the like, of the respective persons in the images, to the server section 90, via the network 70.

Furthermore, the information transmitting/receiving section 73 sends the server section 90 information about a person who is to be identified as a specific person as input by the surveillance operator via the input/output section 72, for example, a person who visited the book section between X o'clock and Y o'clock, or a person who may possibly have committed theft in the book section on the day x of month y, in other words, information about a theft suspect. Moreover, the information transmitting/receiving section 73 receives the information about the specific person to be detected, from the server section 90, and sends this information to the detecting section 81. The input/output section 72 performs the same operations as the input/output section 23 in the first embodiment.

Subsequently, the detecting section 81 performs detection of the specific person identified by the identifying section 21, in a similar manner to the detecting section 31 in the first embodiment. In the present embodiment, the identifying section 111 is situated in the server section 90, and therefore, as illustrated in FIG. 18, the specific person table 82 is situated in the detecting section 81. The detecting section 81 detects the specific person recorded in the specific person table 82, by means of the specific person detecting section 32, and it outputs the detection result thereof to the server section 90 via the detection result outputting section 33. It then receives the personal information recorded in the specific person table 82 from the server section 90.

Next, the operation of the server section 90 will be described.

Firstly, the transmitting/receiving section 91 receives a variety of information from the client sections 60 via the network 70, and it transmits each item of information received to the database section 101 or identifying section 111. The transmitting/receiving section 91 sends information to the database section 101 if the information received from the client section 60 is a record item relating to the attitude, behavior, or the like, of a respective person in the image, whereas it sends the information to the identifying section 111 if the information received from the client section 60 is information about a person who is to be detected. The transmitting/receiving section 91 receives information about a specific person to be detected from the identifying section 111, and sends this information to the client section 60.

The database section 101 is constituted so as to be included in the recording section, and as illustrated in FIG. 19, is comprises a plurality of personal behavior tables 101-1, 101-2 . . . , 101-n, these respective personal behavior tables 101-1, 101-2, . . . , 101-n each corresponding to a respective client section 60. The respective personal behavior tables 101-1, 101-2, . . . 101-n record information in the form of text data indicating “when”, “where”, “what action” within the range of surveillance for each of the persons in the surveillance images captured by the client section 60, and they also record face images of the respective persons.

The identifying section 111 performs operations which are virtually similar to those of the identifying section 21 in the first embodiment. In the present embodiment, however, the identifying section 111 is not provided with a specific person table 82, because the specific person table 82 is situated in the detecting section 81. Moreover, in the first embodiment, the identifying section 21 transmits and receives information about specific persons with the specific person detecting section 22, by means of the input/output section 23, but the identifying section 111 transmits and receives information about specific persons with the specific person detecting section 112, by means of the transmitting/receiving section 71 of the client section 60 and the transmitting/receiving section 91 of the server section 90. Here, the input section of the identifying section 111 is used in cases where information for a person to be detected is input or output externally in the server section 90, or in cases where a surveillance operator spontaneously implements detection of a specific person, in other words, where a surveillance operator accesses the server section 90 and inputs information about a specific person (for example, a person who has conducted suspicious actions), and detects that person, regardless of the fact that there has not been any request from the client section 60.

In this way, the surveillance system 1-C performs detection of specific persons whilst information is exchanged between the plurality of client sections 60 and the single server section 90.

Accordingly, in the surveillance system 1-C according to the present embodiment, the respective client sections 60 perform the functions of the recording section 61 and the detecting section 81, and the server section 90 performs the function of the identifying section 111. Therefore, the present embodiment is able to perform identification of persons more accurately than the first and second embodiments where identification of persons is carried out by means of a single client section 60 only.

Furthermore, by sending information about a specific person to be detected by one particular client section 60, to the plurality of client sections 60, as and when necessary, the surveillance system 1-C according to the present embodiment is able to detect that person in other locations as well. Consequently, the present embodiment can also be applied in cases where it is wished to detect a wanted criminal in a multiplicity of retail outlets located across a broad geographical area, or where it is wished to detect theft suspects or high-spending customers, in all of the retail outlets belonging to a chain of stores, or the like.

Moreover, by distributing functions between the client sections 60 and the server section 90, the surveillance system 1-C according to the present embodiment allows respective functions to be managed independently by different operators. As a result, a person running a retail outlet, or the like, where a client section 60 is located, is able to receive the services offered by the server section 90, rather than having to carry out the management tasks, and the like, performed by the server section 90, by paying a prescribed fee to the operator who runs and manages the server section 90. Therefore, provided that the operator running and managing the server section 90 is a person with the required knowledge to identify persons, in other words, an expert in this field, then it is not necessary to have an expert in the retail outlet, or the like, where the client section 60 is situated.

(Fourth Embodiment)

Below, a fourth embodiment of the present invention is described. Similar operations and elements having the same structure as the first to third embodiments are omitted from this description.

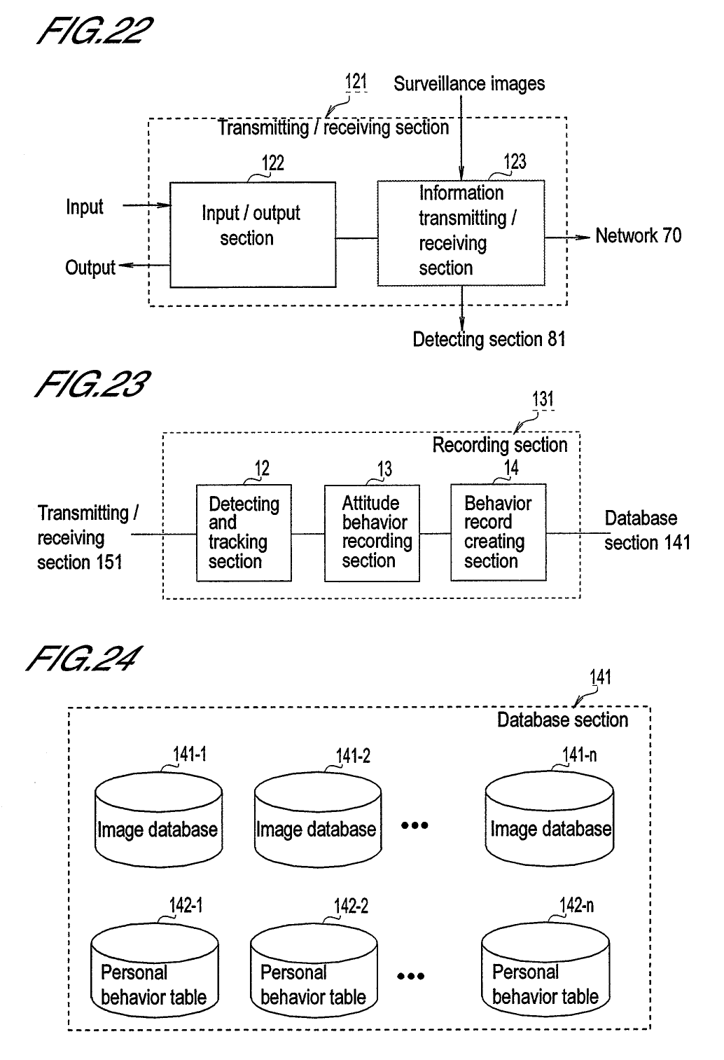

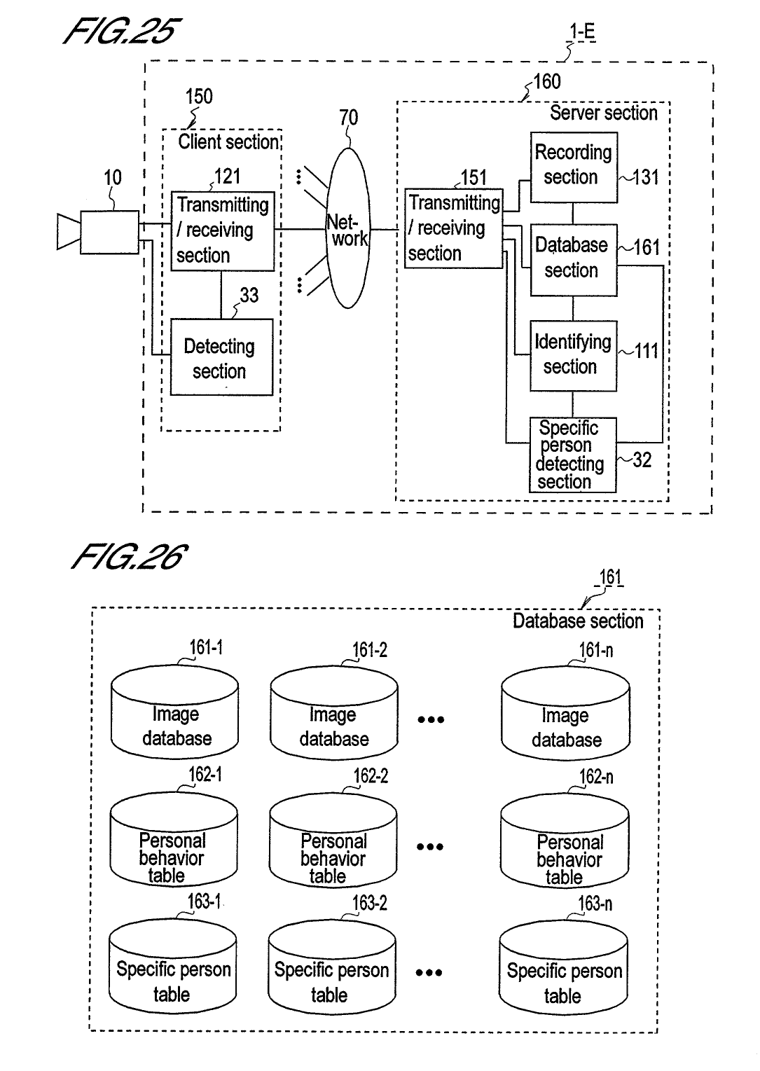

FIG. 21 is a block diagram showing the composition of a surveillance system according to the fourth embodiment of the present invention; FIG. 22 is a block diagram showing the composition of a transmitting/receiving section according to the fourth embodiment of the present invention; FIG. 23 is a block diagram showing the composition of a recording section according to the fourth embodiment of the present invention; and FIG. 24 is a block diagram showing the composition of a database section according to the fourth embodiment of the present invention.

In the surveillance system 1-D according to the present embodiment, similarly to the surveillance system 1-C according to the third embodiment, a client section 120 consisting of a client computer is connected by a network 70 to a server section 130 consisting of a server computer. However, in this embodiment, the client section 120 does not have a recording section 61 and the server section 130 does have a recording section 131.

As shown in FIG. 21, in the surveillance system 1-D, the client section 120 comprises a transmitting/receiving section 121 forming a first transmitting/receiving section and a detecting section 81, and the server section 130 comprises a transmitting/receiving section 151 forming a second transmitting/receiving section, and a recording section 131, database section 141 and identifying section 111.

The transmitting/receiving section 121 is provided with an input/output section 122 and an information transmitting/receiving section 123, as shown in FIG. 22. The recording section 131 comprises a detecting and tracking section 12, attitude and behavior recognizing section 13, and behavior record creating section 14, as illustrated in FIG. 23. The database section 141 comprises a plurality of image databases 141-1, 141-2, . . . , 141-n, and a plurality of personal behavior tables 142-1, 142-2, . . . , 142-n, as illustrated in FIG. 24. The client section 120 and server section 130 are also provided with recording sections (not illustrated), similarly to the third embodiment.

Next, the operation of the surveillance system 1-D will be described. In the surveillance system 1-D according to the present embodiment, the processing carried out by the recording section 61 of the client section 60 in the third embodiment is here performed by the recording section 131 of the server section 130, rather than the client section 120. Apart from this, the operations are similar to those in the third embodiment, and only those points of the operations of the surveillance system 1-D according to the present embodiment which differ from the operations of the surveillance system 1-C according to the third embodiment will be described here.

In the third embodiment, record items relating to a person's behavior, and the like, are exchanged between the client sections 60 and the server section 90, but in the present embodiment, images are exchanged between the client sections 120 and the server section 130. Therefore, although the composition of the transmitting/receiving section 121 in each client section 120 is similar to the composition of the transmitting/receiving section 71 in the third embodiment, it comprises an image encoding and decoding function, such as JPEG, MPEG4, or the like, in order to send and receive images. Any type of method may be adopted for image encoding and decoding.

Similarly to the third embodiment, the transmitting/receiving section 121 in the client section 120 also has functions for sending information about a person who is to be detected to the server section 130, via the input/output section 122, receiving information about the specific person to be detected from the server section 130, and sending that information to the detecting section 81.

The transmitting/receiving section 151 of the server section 130, on the other hand, has an image encoding and decoding function similar to that of the transmitting/receiving section 121 in the client section 120. The transmitting/receiving section 151 decodes the images received from the transmitting/receiving section 121 and sends these images to the recording section 131. Furthermore, the transmitting/receiving section 151, similarly to the transmitting/receiving section 91 in the third embodiment, receives information about a person who is to be detected, from the client section 120, and sends this information to the identifying section 111.

As illustrated in FIG. 23, the recording section 131 of the server section 130 recognizes the attitude and behavior of the respective persons in the images and outputs record items relating to the attitude, behavior, and the like, of the respective persons to the database section 141, in a similar manner to the recording section 61 of the client section 60 in the third embodiment. As shown in FIG. 24, the database section 141 comprises personal behavior tables 142-1, 142-2, 142-n and image databases 141-1, 141-2, . . . , 141-n, corresponding to the respective client sections 120, and it accumulates record items relating to a person's attitude, behavior, and the like, and image data, as sent by the respective client sections 120, in the corresponding personal behavior tables 142-1, 142-2, . . . , 142-n and image databases 141-1, 141-2, . . . , 141-n. The image data accumulated in the respective image databases 141-1, 141-2, . . . , 141-n is, for example, used when the identifying section 111 searches for specific persons. Furthermore, when there has been a request from a client section 120 to the server section 130 to reference the image data for a particular day and time, then the image data are encoded by the transmitting/receiving section 151 and sent from the server section 130 to the client section 120.

The detecting section 81, identifying section 111, and the like, detect specific persons by performing similar processing to that in the third embodiment.

In this way, in the surveillance system 1-D of the present embodiment, the server section 130 is able to accumulate and manage images and record items relating to the attitude, behavior, and the like, of persons, universally, by means of images being sent from the client sections 120 to the server section 130, and therefore the work of managing the record items and images, and the like, in the respective client sections 120 can be omitted.

Moreover, in the surveillance system 1-D according to the present embodiment, since the recording section 131 is situated in the server section 130 only, maintenance, such as upgrading, is very easy to carry out. Furthermore, since the composition of the client sections 120 is simplified in the surveillance system 1-D, servicing costs can be reduced. Consequently, with the surveillance system 1-D it is possible to situate client sections 120 in a greater number of locations whilst maintaining the same expense.

Since the functions of the surveillance system 1-D are divided between the client sections 120 and server section 130, respective functions can be managed independently by different operators. As a result, a person running a retail outlet, or the like, where a client section 120 is located, is able to receive the services offered by the server section 130, rather than having to carry out the management tasks, and the like, performed by the server section 130, by paying a prescribed fee to the operator who runs and manages the server section 130. Therefore, the operator running and managing the server section 130 is able to undertake the principle tasks of identifying persons, as well as the accumulation and management of surveillance images.

(Fifth Embodiment)

Below a fifth embodiment of the present invention is described. Similar operations and elements having the same structure as the first to fourth embodiments are omitted from this description.

FIG. 25 is a block diagram showing the composition of a surveillance system according to a fifth embodiment of the present invention; and FIG. 26 is a block diagram showing the composition of a database section according to a fifth embodiment of the present invention.

Similarly to the surveillance system 1-D, in the surveillance system 1-E according to the present embodiment, client sections 150 and a server section 160 are connected by means of a network 70. However, in the surveillance system 1-E according to the present embodiment, the client sections 150 comprise a detection result outputting section 33, instead of a detecting section 81, and the server section 160 is provided with a specific person detecting section 32.

As shown in FIG. 25, the surveillance system 1-E, the client section 150 comprises a transmitting/receiving section 121 and detection result outputting section 33, and the server section 160 comprises a transmitting/receiving section 151, recording section 131, database section 161, identifying section 111, and specific person detecting section 32.

As illustrated in FIG. 26, the database section 161 comprises a plurality of image databases 161-1, 161-2, . . . , 161-n, a plurality of personal behavior tables 162-1, 162-2, . . . , 162-n, and specific person tables 163-1, 163-2, . . . , 163-n.

Next, the operation of the surveillance system 1-E will be described.

In the surveillance system 1-E according to the present embodiment, the principal parts of the processing carried out by the detecting section 81 in the fourth embodiment are performed by the server section 160. Therefore, the server section 160 is provided with a specific person detecting section 32 for detecting specific persons, and specific person tables 163-1, 163-2, . . . , 163-n, and the client section 150 is provided with a detection results outputting section 33 for outputting detection results. Apart from this, the operation is similar to the fourth embodiment, and therefore only the operations of the surveillance system 1-E according to the present embodiment which are different to the operations of the surveillance system 1-D according to the fourth embodiment will be described.

In the fourth embodiment, the client section 120 performs specific person detection, but in the present embodiment, the server section 160 carries out specific person detection. This is because surveillance images are sent to the server section 160, and therefore the server section 160 is able to detect specific persons by processing the surveillance images. The detection results from the server 160 are sent to the client section 150 via the network 70, and is also output externally by means of the detection result outputting section 33.

The server section 160 creates specific person tables 163-1, 163-2, . . . , 163-n corresponding to the respective client sections 150. Therefore, the database section 161 is provided with a plurality of specific person tables 163-1, 163-2, . . . , 163-n corresponding to the respective client sections 150. These specific person tables 163-1, 163-2, . . . , 163-n are referenced by the specific person detecting section 32 of the server section 160 and used to detect specific persons.

In respect of points other than those described above, similar processing to that of the third embodiment is performed in the detection of specific persons.

In this way, in the surveillance system 1-E according to the present embodiment, since processing up to detection of the specific persons is performed by the server section 160, the client sections 150 only comprise a transmitting/receiving section 121 for exchanging images and information with the surveillance camera 10 and server section 160, and a detection result outputting section 33 for externally outputting the detection results. Therefore, in the surveillance system 1-E, maintenance, such as upgrading, can be performed readily. Moreover, since the client sections 150 of the surveillance system 1-E have a simplified composition, it is possible to reduce equipment costs. Therefore, the surveillance system 1-E permits client sections 150 to be installed in a greater number of locations, for the same expense.

Furthermore, by dividing the functions between the client sections 150 and the server section 160, the surveillance system 1-E allows the respective sections to be managed by different people, independently. As a result, a person running a retail outlet, or the like, where a client section 150 is located, is able to receive the services offered by the server section 160, rather than having to carry out the management tasks, and the like, performed by the server section 160, by paying a prescribed fee to the operator who runs and manages the server section 160.

The descriptions of the first to fifth embodiments envisaged use of the surveillance system in a retail outlet, such as a convenience store, but the surveillance system according to the present invention is not limited to application in a retail outlet, and may also be applied to various facilities and locations, such as: commercial facilities, such as a department store, shopping center, or the like, a financial establishment, such as a bank, credit association, or the like, transport facilities, such as a railway station, a railway carriage, underground passage, bus station, airport, or the like, entertainment facilities, such as a theatre, theme park, amusement park, or the like, accommodation facilities, such as a hotel, guesthouse, or the like, dining facilities, such as a dining hall, restaurant, or the like, public facilities, such as a school, government office, or the like, housing facilities, such as a private dwelling, communal dwelling, or the like, the interiors of general buildings, such as entrance halls, elevators, or the like, or work facilities, such as construction sites, factories, or the like.

Furthermore, by means of detecting not only persons requiring observation, such as theft suspects, wanted criminals, and the like, but also consumers displaying a particular consumption pattern, such as high-spending customers, then the surveillance system according to the present invention is able to analyze the consumption behavior of individual customers. Moreover, the surveillance system is also able to analyze the behavior patterns of passengers, users, workers, and the like, by, for instance, detecting passengers using a particular facility of a transport organization, such as a railway station, detecting users who use a particular amusement facility of a recreational establishment, or detecting a worker who performs a particular task in a construction site, or the like.

Moreover, the surveillance system according to the first and second embodiments is able to control the recording section 2 connected to the surveillance system, on the basis of the person detection and tracking results of the detection and tracking section 12 in the recording sections 11, 41, 61, and the results of the attitude and behavior recognizing section 13. Thereby, the surveillance system can perform control whereby, for instance, image recording is only carried out when persons are present.

In the surveillance system according to the third to fifth embodiments, a plurality of the surveillance cameras 10-1, 10-2, . . . , 10-n according to the second embodiment may be used interchangeably as the surveillance camera 10. Moreover, the surveillance system also permits use of a plurality of surveillance cameras 10-1, 10-2, . . . , 10-n in a portion of the client sections only. Furthermore, a plurality of server sections may also be adopted in the surveillance system. In this case, it is possible to distribute the processing load of a single server section. Moreover, it is not necessary for a plurality of client sections to be provided, and only one client section may also be used.

The present invention is not limited to the embodiments and may be modified variously on the basis of the essence of the present invention, and such modifications are not excluded form the scope of the claims.

As described in detail above, according to the present invention, since a personal behavior table is created from surveillance images, and persons are identified and detected on the basis of this personal behavior table, it is possible to perform detection of various specific persons readily, in a variety of fields.

What is claimed is:

1. A surveillance system comprising:
(a) a recording section for recognizing the behavior of a person depicted in a surveillance image, creating record items on the basis of said behavior, in an editable and processable format, and recording said record items in a personal behavior table;
(b) an identifying section for searching for a specific person on the basis of the record items recorded in said personal behavior table, and creating information for a specific person, and a specific person table wherein items for identifying a specific person are recorded; and
(c) a detecting section for detecting a person for whom information is recorded in said specific person table, from a surveillance image.

2. The surveillance system according to claim 1, wherein said recording section comprises: a detecting and tracking section for detecting a person from said surveillance image and tracking this person; an attitude and behavior recognizing section for recognizing the attitude and behavior of said person; and a behavior record creating section for processing the recognition results of said attitude and behavior recognizing section into an editable and processable format.

3. The surveillance system according to claim 1, wherein said identifying section comprises a specific person searching section for searching for a specific person on the basis of the record items recorded in said personal behavior table, and an input/output section for performing input/output of personal information in order to perform a search.

4. The surveillance system according to claim 1, wherein said detecting section comprises a specific person detecting section for detecting a specific person for whom information is recorded in said specific person table, from said surveillance image, and a detection result outputting section for displaying the detected result.

5. The surveillance system according to claim 1, further comprising a database section for storing a personal behavior table in which said record items are recorded in an editable and processable format.

6. The surveillance system according to claim 5, wherein said database section comprises a plurality of said personal behavior tables corresponding to respective client sections.

7. The surveillance system according to claim 6, wherein said database section further comprises a plurality of image databases or specific person tables corresponding to respective client sections.

8. The surveillance system according to claim 1 or 5, wherein said personal behavior table contains any from among a face image, a full-body image, and behavior of the person, and location where or timing when the person is present.

9. The surveillance system according to claim 1 or 3, wherein said specific person table contains the record items recorded in said personal behavior table, and items by which said persons are classified.

10. The surveillance system according to claim 1 or 4,
wherein said detecting section comprises a detection result outputting section for outputting the result of detecting a specific person depicted in said surveillance image; and
said detection result outputting section outputs an item by which the detected person is classified, externally, in such a manner that the person can be identified by means of any one of an image, voice and warning sound, or a combination thereof.

11. The surveillance system according to claim 1, wherein said detecting section and said recording section are able to input surveillance images of different angles, captured by a plurality of surveillance cameras.

12. The surveillance system according to claim 1, wherein said detecting section, said recording section and said identifying section are located in either a client section or a server section, and a person for whom information is recorded in said specific person table is detected from the surveillance image by means of transmitting and receiving information between the client section and the server section.

13. The surveillance system according to claim 12, wherein said recording section and said detecting section are located in said client section, and said identifying section is located in said server section.

14. The surveillance system according to claim 12, wherein said detecting section is located in said client section, and said recording section and said identifying section are located in said server section.

15. The surveillance system according to claim 12, wherein said client section and said server section are respectively provided with transmitting/receiving sections capable of transmitting and receiving information including surveillance images.

16. A surveillance method comprising:
(a) a step in which, in a client section, the behavior of a person depicted on a surveillance image is recognized, record items is created in an editable and processable format, on the basis of said behavior, and said record items are recorded and at the same time transmitted to a server section;
(b) a step in which, in said server section, said record items are recorded and at the same time a specific person is searched for on the basis of said record items, and information for the specific person thus found is sent to said client section; and
(c) a step in which, in said client section, said specific person is detected from said surveillance image on the basis of the information for said specific person.

17. A surveillance method comprising:
(a) a step in which, in a client section, a surveillance image is sent to a server section;
(b) a step in which, in said server section, the behavior of a person depicted on said surveillance image is recognized, record items are created in an editable and processable format, on the basis of said behavior, said record items are recorded and at the same time a specific person is searched for on the basis of said record items, and information for the specific person thus found is transmitted to said client section; and
(c) a step in which, in said client section, said specific person is detected from said surveillance image on the basis of the information for said specific person.

18. A surveillance program for detecting specific persons by causing (a) a computer to function as:
(b) a recording section for recognizing the behavior of a person depicted in a surveillance image, creating record items on the basis of said behavior, in an editable and processable format, and recording said record items in a personal behavior table;
(c) an identifying section for searching for a specific person on the basis of the record items recorded in said personal behavior table, and creating information for a specific person, and a specific person table in which items for identifying a specific person are recorded; and
(d) a detecting section for detecting a person for whom information is recorded in said specific person table, from a surveillance image.

19. The surveillance program according to claim 18, for detecting specific persons by (a) causing a computer to function as:
(b) a client section comprising said recording section and said detecting section; and
(c) a server section comprising a database section storing said personal behavior table, and said identifying section; and
(d) communicating required information between said client section and server section.

20. The surveillance program according to claim 18 for detecting specific persons by (a) causing a computer to function as:
(b) a client section comprising said detecting section; and
(c) a server section comprising said recording section, a database section storing said personal behavior table and said surveillance images, and said identifying section; and
(d) communicating required information between said client section and server section.
